(19) United States
(12) Patent Application Publication
(10) Pub. No.: US 2021/0245821 A1
(43) Pub. Date: Aug. 12, 2021

(54) AGRICULTURAL VEHICLE CHASSIS WITH ADJUSTABLE WIDTH AND AGRICULTURAL VEHICLE

(71) Applicant: CYBELIUM TECHNOLOGIES, CONQUES-SUR-ORBIEL (FR)

(72) Inventor: Pierre CROUZAT, CONQUES SUR ORBIEL (FR)

(21) Appl. No.: 16/973,403

(22) PCT Filed: Jun. 7, 2019
(86) PCT No.: PCT/FR2019/051375

§ 371 Date: Dec. 8, 2020

(30) Foreign Application Priority Data
Jun. 8, 2018 (FR) 18.55044

(51) Int. Cl. B62D 49/06

(52) U.S. Cl. CPC B62D 49/0607

(57) ABSTRACT

The invention relates to an agricultural vehicle chassis comprising two lateral half-chassis (21, 22) connected to each other and a device for adjusting the relative distance between the two lateral half-chassis (21, 22) allowing the width of the chassis to be varied and comprising at least one torque link (41, 42) formed by two rigid arms which are hinged to each other by a joint, named central joint (53, 73), comprising a pivot with a vertical axis allowing the two arms to be oriented with respect to each other so that they form an angle, named torque link angle, therebetween, said angle ranging between 0° and 180°, each arm of the torque link being hinged, respectively, to one of the two lateral half-chassis by a joint, named lateral joint (49, 50, 69, 70), comprising a pivot with a vertical axis, and a device for adjusting the torque link angle. The invention also relates to a vehicle equipped with such a chassis.

The invention relates to an agricultural vehicle chassis, the width of which is adjustable, and to an agricultural vehicle provided with such a chassis.

The adjustment of the width of an agricultural vehicle chassis allows the agricultural vehicle to be adapted to various uses, as a function of the sizes of the plantations for which the vehicle is used and/or of the agricultural processing to be performed. Agricultural vehicles are already known of the high-clearance type, the width and/or the track of which can be adjusted by virtue of telescopic cross-members and/or cylinders connecting two lateral half-chassis.

Such telescopic cross-members require particularly complex and expensive translational guide means, of the type that are like those of the telescopic arms of construction plant equipment, so as to avoid the presence of any unintentional play between the two half-chassis. In this respect, it is to be noted that the consequence of any wear in these guide means is the appearance or an increase of deflection play in the telescopic cross-members, with such play also leading to an increase in any wear, stresses, shocks and risks of breakage.

Furthermore, such cross-members, which basically work under deflection, generate very high stresses on these guide means, which, in practice, must be significantly over-dimensioned for the maximum width position of the chassis (whereas the time that the vehicle operates in this position is, in practice and in most cases, very low, even zero). Furthermore, such telescopic cross-members have the disadvantage of reducing the deflection resistance of the guide means during deployment.

Furthermore, such telescopic cross-members and/or cylinders provide a small range of variation of the width of the chassis in relation to the minimum width space requirement of the chassis. Indeed, with each telescopic cross-member being formed by an internal bar sliding in an external bar, the range of variation of the width of the chassis is limited by the length of the internal bar, and said internal bar is limited by the length of the external bar, unless it is accepted that the internal bar extends by projecting beyond the outer end of the external bar, to the detriment of the width space requirement of the chassis and of the vehicle. However, it is to be noted that the width space requirement of an agricultural vehicle is a very important parameter for the use of the agricultural vehicle, in particular in the minimum width position. Indeed, this space requirement must be compatible with the travel of the agricultural vehicle over the terrain, between the rows of plants. Furthermore, the agricultural vehicle must not have laterally projecting rods or bars, which could constitute a significant risk in terms of traffic safety, both for the vehicle itself and for third parties. Thus, for example, for a minimum width dimension of approximately 0.8 m, corresponding to the total length of the internal bar of a telescopic cross-member, the increase in the width of the chassis is at most approximately 0.6 m, that is a maximum length of 1.4 m.

Additionally, the non-manual activation of such telescopic cross-members poses a problem, with the gearing-down of the movements generally being impossible or complex, expensive, onerous and troublesome.

Additionally, such telescopic cross-members are not very compatible with the agricultural vehicles that are most often used in severe environmental conditions, with projections of mud, stones, sand, earth, . . . , subject to corrosion and to chemical attacks. Indeed, such conditions pose the risk of premature ageing of the guide means, or the introduction of solid particles between the bars of the telescopic cross-members, which can lead to jamming or premature wear. The protective elements that can be added to protect the guide means from the outside, which elements can be formed by bellows, seals or membranes, are themselves subject to wear and to ageing and must undergo periodic checks and maintenance.

Furthermore, such telescopic cross-members are not optimal in terms of the general rigidity and of the deformation resistance of the chassis.

Therefore, the invention aims to overcome these disadvantages.

In particular, it aims to propose an agricultural vehicle chassis with adjustable width that is simpler, more economical, and in which any play and stresses are simply and economically managed, in a similar manner for all the width values of the chassis, without requiring over-dimensioning.

The invention also aims to propose an agricultural vehicle chassis having a wide range of width variation, without compromising the width space requirement of the vehicle, in particular its minimum space requirement in the minimum width position. In this respect, the invention also aims to propose an agricultural vehicle chassis providing perfect operating safety.

The invention also aims to propose an agricultural vehicle chassis with adjustable width that is compatible with its use in all agricultural environments, including the most severe environments, having a long service life and not requiring regular, specific checking and maintenance operations.

It also aims to propose an agricultural vehicle chassis, for which the general rigidity in relation to its total weight is increased.

It also aims to propose an agricultural vehicle chassis allowing a versatile agricultural vehicle to be produced, and allowing simple and rapid installation of various agricultural processing devices allowing the agricultural vehicle to be used for the various agricultural processing operations to be performed throughout the seasons.

It also aims to propose a chassis allowing various types of agricultural vehicles to be produced: self-propelled vehicles driven by an on-board driver, remotely driven self-propelled vehicles, in particular remote controlled, robotic vehicles, . . .

The invention also aims to propose an agricultural vehicle having the same advantages.

To this end, the invention relates to an agricultural vehicle chassis comprising:
two lateral half-chassis connected to each other at a distance from each other so as to form a rigid structure,
a device for adjusting the relative distance between the two lateral half-chassis, said adjustment device comprising:
   at least one torque link:
      comprising two rigid arms, which are hinged in relation to each other by a joint, named central joint:
         comprising a pivot,
         and allowing the two arms to be oriented in relation to each other so that they together form an angle, named torque link angle, ranging between 0° and 180°,
      each arm of the torque link being hinged, respectively, on one of the two lateral half-chassis by a joint, named lateral joint, comprising a pivot,
      said pivots of the central joint and of the lateral joints having pivot axes that are parallel to each other,
   a device for adjusting the torque link angle, said device for adjusting the torque link angle being adapted to allow the torque link angle to be locked once adjusted,
      characterised in that the device for adjusting the torque link angle of at least one torque link, in particular of each torque link, comprises a cylinder comprising a body supported by one of the two arms of the torque link and an activation rod hinged on the other arm of the torque link.

A chassis and an agricultural vehicle according to the invention define a main forward movement axis, named longitudinal axis, corresponding to a preferred forward movement axis of the agricultural vehicle when it performs agricultural work. This longitudinal axis is also generally the axis along which the chassis according to the invention has the greatest overall dimension. The width of a chassis according to the invention is a dimension thereof along a horizontal axis orthogonal to said longitudinal axis. Similarly, a forwards orientation and a rearwards orientation can be defined along said longitudinal axis, whether the agricultural vehicle according to the invention has a preferred direction, named forward direction, for advancing along said longitudinal axis, or whether, on the contrary, the agricultural vehicle according to the invention is adapted to be able to move in both directions along said longitudinal axis, in which case any one of the longitudinal ends of the chassis is denoted front end, with the other opposite longitudinal end being denoted rear end.

In a chassis according to the invention, the adjustment of the distance separating the two lateral half-chassis, i.e. the width of the chassis, involves rotation movements along pivots that have substantially constant mechanical features and experience similar mechanical stresses throughout the entire range of variations of the width of the chassis. Such pivots are also particularly simple and economical, light and compact, and have mechanical features that have been perfectly mastered for many years. They are much more compatible with the severe agricultural environments than the translational guides. They have a long service life, and do not require specific, regular checking and maintenance operations.

Furthermore, a width adjustment by a torque link allows a significant variation of width dimensions to be obtained, which typically can range between 0.5 m and 3 m (in particular between 0.8 m and 2 m), without compromising the width space requirement of the chassis, in particular for the minimum width value.

The invention is applicable in some embodiments in which the two lateral half-chassis are not strictly identical to each other, and are even different in terms of their shapes and dimensions. Nevertheless, in some advantageous embodiments of the invention, the two lateral half-chassis have the same shapes and dimensions.

In a chassis according to the invention, each torque link also forms a rigid (but width-adjustable) mechanical link between the two lateral half-chassis. The invention particularly allows any translational guidance for the width adjustment of the chassis to be limited, and even obviated. However, nothing precludes the provision of some translationally guided parts as required. Nevertheless, even in this variant, the width adjustment mainly can be obtained by each torque link of the adjustment device, and by the device for adjusting the corresponding torque link angle, so that any translationally guided parts do not bear most of the forces imparted between the two lateral half-chassis.

Furthermore, contrary to translational guidance, rotary guidance can be activated by an actuator connected to a transmission, with said actuator and said transmission being able to be selected so as to optimise their specific features in terms of power and travel, in a simple, economical, light and compact manner.

Furthermore, a chassis according to the invention also has the advantage of significantly simplifying the mechanical link between the two lateral half-chassis and the activation of the adjustment device, which can be simply motorised.

Thus, in some advantageous embodiments according to the invention, said adjustment device, which forms the mechanical link between the two lateral half-chassis, comprises at least one actuator (with this term denoting any device delivering mechanical energy from energy of a type other than mechanical energy: cylinder, motor, . . . ) of at least one device for adjusting the torque link angle of at least one torque link.

More specifically, in some advantageous embodiments of the invention, said adjustment device comprises, exclusively as an actuator, at least one such actuator of at least one device for adjusting the torque link angle of at least one torque link. In other words, only at least one torque link, in particular each torque link, of the adjustment device is activated, and said adjustment device does not have any other actuator.

Preferably, the adjustment device also comprises at least one strengthening cylinder comprising:
a body supported by one from among a lateral half-chassis and an arm of a torque link, the arm being hinged on this half-chassis; and
an activation rod supported by the other one from among said lateral half-chassis and said arm of said torque link.

This strengthening cylinder allows an undesired rotation to be avoided at the links between each arm of the torque link and the two half-chassis. Thus, the strengthening cylinder prevents a movement of the half-chassis in relation to each other. Preferably, the adjustment device comprises a strengthening cylinder for each torque link so as to improve the stiffness of the chassis.

Advantageously and according to the invention, said pivots of the central joint and of the lateral joints of each torque link are non-sliding pivots (i.e. without any possibility of translation movement parallel to the pivot axis) and have pivot axes that are parallel to each other.

In some advantageous embodiments of the invention, said central joint of at least one torque link, in particular of each torque link, comprises a non-sliding pivot with a vertical axis (i.e. orthogonal to the running surface of the wheels of the vehicle that is assumed to be horizontal), in particular it is formed by a non-sliding pivot with a vertical axis. Similarly, each lateral joint of at least one torque link, in particular of each torque link, comprises a non-sliding pivot with a vertical axis, in particular it is formed by a non-sliding pivot with a vertical axis. Such a torque link, for which the pivot axes are vertical and for which the arms are straight beams, extends in a horizontal plane. In these embodiments, a chassis according to the invention comprising a plurality of torque links exhibits improved rigidity by virtue of a buttress effect resulting from the torque links.

However, nothing precludes, in some variants, the provision for said central joint of at least one torque link, in particular of each torque link, to comprise a non-sliding pivot with a non-vertical axis (i.e. not orthogonal to the running surface of the wheels of the vehicle that is assumed to be horizontal), in particular for said central joint to be formed by a non-sliding pivot with a non-vertical axis. Additionally, nothing precludes the provision for the lateral joints of at least one torque link, in particular of each torque link, to each comprise a non-sliding pivot with a non-vertical axis, in particular for each lateral joint to be formed by a non-sliding pivot with a non-vertical axis. Such a torque link then extends in a non-horizontal plane and can be inclined, for example, upwards or downwards in relation to the two lateral half-chassis. It is even possible for provision to be made so that the pivots of the central and lateral joints of at least one torque link, in particular of each torque link, have horizontal pivot axes. Such a torque link, for which the arms are straight beams, then extends in a vertical plane.

Additionally, nothing precludes, in some variants, the provision of a central joint having other degrees of freedom, depending on the requirements, for example, in the form of a ball joint, yet subject to the provision of a corresponding adjustment device allowing each other degree of freedom to be controlled and allowing it to be locked once adjusted.

Additionally, nothing precludes, by way of a variant, the provision of at least one lateral joint of at least one torque link, in particular of each torque link, having other degrees of freedom, depending on the requirements, for example, in the form of a ball joint, yet subject to the provision of a corresponding adjustment device allowing each other degree of freedom to be controlled and allowing it to be locked once adjusted.

The rigid arms of each torque link of a chassis according to the invention can be the subject of various alternative embodiments. Any device allowing a distance to be defined between two ends (one corresponding to the central joint, the other corresponding to a lateral joint) can be used by way of a rigid arm in a torque link of a chassis according to the invention. In some preferred embodiments, these arms are formed by straight beams, for example, with metal profile sections; however, nothing precludes the provision of arms having shapes other than a straight shape, for example curved in a horizontal plane and/or in a vertical plane and/or in any other plane, or in the form of broken lines . . . Additionally, nothing precludes the provision of at least one rigid arm, in particular the rigid arms of at least one torque link, in particular of each torque link, of adjustable length, for example in the form of telescopic arms. Preferably, the two rigid arms of at least one single torque link, in particular of each torque link, have the same length. However, nothing precludes the provision for a torque link, in particular each torque link, to have rigid arms with different lengths, if the need arises.

In a chassis according to the invention, the device for adjusting the torque link angle can be the subject of various structural variants, provided that it allows effective adjustment of the torque link angle value and allows it to be locked once adjusted. For example, such a device for adjusting the torque link angle can cooperate with the central joint and/or at least one lateral joint and/or each lateral joint of the torque link. Advantageously and according to the invention, the device for adjusting the torque link angle of at least one torque link, in particular of each torque link, is adapted to allow angular adjustment of the central joint and to allow said central joint to be locked once adjusted.

In a chassis according to the invention, the torque link angle of each torque link always remains oriented in the same direction in relation to said longitudinal axis, i.e. either towards the front or towards the rear, irrespective of the value of the width of the chassis.

In principle, nothing precludes the torque link angle from being able to adopt the value 0° and/or the value 180°. Nevertheless, in some advantageous embodiments, the device for adjusting the torque link angle of at least one torque link, in particular of each torque link, is adapted to set a torque link angle value above 0° and below 180°, values excluded. In this way, the two arms of the torque link always together form a non-zero angle, which in practice imparts significant general rigidity to the chassis according to the invention and significantly facilitates the activation of the adjustment device. Furthermore, since the two arms cannot be aligned in relation to each other, this avoids any risk of unintentional locking. In practice, advantageously and according to the invention, the adjustment device is adapted to set a torque link angle value greater than or equal to 20°, more specifically greater than or equal to 30°, even more specifically greater than or equal to 45°. Similarly, advantageously and according to the invention, the adjustment device is adapted to set a torque link angle value less than or equal to 160°, more specifically less than or equal to 150°, even more specifically less than or equal to 145°.

Said device for adjusting a chassis according to the invention can comprise a variable number of torque links, depending on the requirements and the applications.

In particular, nothing precludes the provision, in some variants, for said adjustment device to comprise a single torque link, for example placed at the centre of the chassis along said longitudinal axis. In these variants, each lateral joint is provided with a locking device allowing it to be locked in position following the adjustment of the width of the chassis, i.e. following the adjustment of the torque link angle, so that the angular position of each lateral half-chassis, in relation to each torque link arm on which it is hinged, is kept fixed, with the orientation of each lateral half-chassis in relation to each other and in relation to said longitudinal axis remaining the same irrespective of the width of the chassis.

In other variants, advantageously and according to the invention, said adjustment device comprises at least two torque links. In particular, said adjustment device advantageously comprises a plurality of torque links evenly distributed along said longitudinal axis, oriented in the same direction and/or in opposite directions. For example, said adjustment device can comprise at least one front torque link, at least one central torque link and at least one rear torque link.

Thus, in these variants, said adjustment device comprises a plurality of torque links and a unit for controlling the device for adjusting the torque link angle of the various torque links, with said control unit being adapted to keep the same relative orientation of the two lateral half-chassis in relation to each other and in relation to said longitudinal axis. In particular, the two lateral half-chassis are kept generally parallel to each other and to the longitudinal axis. Preferably, said control unit is also adapted to synchronously control the device for adjusting the torque link angle of the various torque links.

In some advantageous embodiments according to the invention, said adjustment device comprises at least one front torque link, for which the peak of the torque link angle is oriented towards the front, and at least one rear torque link, for which the peak of the torque link angle is oriented towards the rear. In particular, said adjustment device comprises a front torque link and a rear torque link. In these embodiments, said control unit is adapted to control the device for adjusting the torque link angle of the front and rear torque links.

In some advantageous embodiments according to the invention, said adjustment device comprises two torque links with opposite torque link angles oriented outwards in relation to each other, i.e. a front torque link with a torque link angle, the peak of which is oriented towards the front, and a rear torque link with a torque link angle, the peak of which is oriented towards the rear. This arrangement in effect allows, on the one hand, an optimal central space to be provided for housing agricultural processing devices (in particular instruments, machinery or tooling) and, on the other hand, imparts inertia and optimal rigidity to the chassis through a buttress effect, in particular in the case in which the pivot axes of the central and lateral joints of the torque links are vertical, as indicated above.

In the embodiments in which the adjustment device comprises a plurality of torque links, preferably, the various torque links have the same dimensions and, in any position for adjusting the width of the chassis, the same torque link angle values. In particular, the front and rear torque links have the same dimensions and the same torque link angles. In this way, the variations of the torque link angle controlled by the control unit simply need to be the same for the various torque links to ensure that the relative orientation of the two lateral half-chassis in relation to each other is maintained, in particular their parallelism, irrespective of the width of the chassis.

According to another aspect, the invention relates to an agricultural vehicle chassis comprising:
two lateral half-chassis connected to each other at a distance from each other so as to form a rigid structure,
a device for adjusting the relative distance between the two lateral half-chassis (and therefore the width of the chassis),
   characterised in that each lateral half-chassis comprises:
a spar,
a front upright extending vertically at least upwards from a front end of the spar,
a rear upright extending vertically at least upwards from a rear end of the spar.

Such an agricultural vehicle chassis provides many advantages: it is compatible with a great many agricultural processing devices (in particular instruments, machinery or tooling) that can be easily installed and rigidly fixed at the centre of the chassis, between the two spars and/or in front of the front uprights and/or behind the rear uprights, both in the immediate vicinity of the ground and by height; it exhibits high rigidity for a reduced weight; it allows easy fitting of the wheels in front of the front uprights and behind the rear uprights; it equally allows easy production of a self-propelled remote controlled, even robotic, agricultural vehicle, and of a self-propelled agricultural vehicle driven by a human operator; it allows at least one seat to be accommodated that is intended to accommodate a human operator (agricultural processing driver and/or operator), the positioning of which seat can be the subject of numerous variants as a function of the use of the agricultural vehicle (for example, close to the ground for market gardening or at a height for processing shrubs) . . .

In particular, the invention also relates to an agricultural vehicle chassis comprising:
two lateral half-chassis connected to each other at a distance from each other so as to form a rigid structure,
a device for adjusting the relative distance between the two lateral half-chassis (and therefore the width of the chassis),
   characterised in that said adjustment device comprises at least one torque link formed by two rigid arms, which are hinged in relation to each other by a joint, named central joint, comprising a non-sliding pivot with a vertical axis, allowing the two arms to be oriented in relation to each other so that they together form an angle, named torque link angle, ranging between 0° and 180°, with each arm of the torque link being hinged, respectively, on one of the two lateral half-chassis by a joint, named lateral joint, comprising a non-sliding pivot with a vertical axis, in that each lateral half-chassis comprises:
a spar,
a front upright extending vertically at least upwards from a front end of the spar,
a rear upright extending vertically at least upwards from a rear end of the spar,
   and in that the adjustment device comprises a front torque link extending between the front uprights hinged thereon, and a rear torque link extending between the rear uprights and hinged thereon.

This combination of features also provides many advantages. In particular, it makes it possible to simply and economically obtain a chassis, for which the weight/rigidity ratio is particularly low, exhibiting high versatility and allowing a very large number of different agricultural processing devices (in particular instruments and/or machinery and/or tooling) to be accommodated, for which the width adjustment is particularly simple and reliable and can be performed over a wide width variation range, for which the mechanical features remain substantially the same, in particular without play and with high rigidity, irrespective of the width at which it is adjusted, which is compatible with all agricultural environments, including the most severe environments, which has a long service life and only requires limited maintenance, which allows various types of agricultural vehicles to be produced: self-propelled vehicles driven by an on-board driver, remotely driven self-propelled vehicles, in particular remote-controlled, robotic vehicles, . . .

In some embodiments, the front and rear uprights can also extend downwards, from the corresponding ends of the spar, with the lateral half-chassis having a general H-shape. In these embodiments, the uprights preferably extend upwards over a height that is greater than their downwards height in relation to the spar (with the spar being in the lower part).

More specifically, in some possible embodiments, each lateral half-chassis comprises:
a lower spar;
a front upright extending vertically upwards from a front end of the lower spar;
a rear upright extending vertically upwards from a rear end of the lower spar,
   and in that the adjustment device comprises a front torque link extending between the front uprights hinged thereon, and a rear torque link extending between the rear uprights and hinged thereon.

More specifically, the front and rear uprights only extend upwards from the spar, with the lateral half-chassis having a general U-shape.

In some advantageous embodiments according to the invention, each torque link is hinged between the upper ends of said uprights. In this way, the space between the two lateral half-chassis is kept free over the entire height of the uprights.

In some advantageous embodiments of a chassis according to the invention, each lateral half-chassis is formed by a rigid metal structure of beams and plates that are rigidly assembled together, in particular by bolting and/or welding and/or riveting.

In particular, each lateral half-chassis is advantageously provided with pairs of perforated plates, with the plates of each pair of perforated plates being parallel and spaced apart from each other by an identical distance for all the pairs of perforated plates, so as to allow the insertion and the bolted assembly of at least one assembly clamp of an agricultural processing device between the two plates of each pair of perforated plates. In particular, the two plates of each pair of perforated plates are bolted together and/or on both sides of at least one beam of the lateral half-chassis.

The plates of these pairs of perforated plates can extend following any orientation. In some embodiments according to the invention, each lateral half-chassis is provided with pairs of perforated longitudinal vertical plates having transverse horizontal holes, with the plates of each pair of longitudinal vertical plates being transversely spaced apart from each other by an identical distance for all the pairs of perforated plates, so as to allow the insertion and the bolted assembly, between the two plates of each pair, of at least one assembly clamp of an agricultural processing device. In particular, the two plates of each pair of perforated longitudinal vertical plates are bolted together and/or on either side of at least one beam, in particular of a spar and/or of an upright, of the lateral half-chassis.

In particular, in some possible embodiments, each lateral half-chassis of a chassis according to the invention is formed by:
a lower spar,
a front upright extending vertically upwards from a front end of the lower spar,
a rear upright extending vertically upwards from a rear end of the lower spar,
pairs of perforated median longitudinal vertical plates bolted from one side to the other of the lower spar,
at least one pair of perforated front longitudinal vertical plates bolted from one side to the other of the front upright,
at least one pair of perforated rear longitudinal vertical plates bolted from one side to the other of the rear upright.

Indeed, it transpires that such a particularly simple structure surprisingly exhibits very high mechanical performance capabilities (in particular a low weight/rigidity and resistance ratio) and significant versatility with respect to the installation of the various agricultural processing devices. In particular, such agricultural processing devices of various types can be fixed between the lower spars and between the uprights and/or in front of the front uprights and/or behind the rear uprights.

In some advantageous embodiments, a chassis according to the invention further comprises at least one platform extending between the two lateral half-chassis and adapted to be able to support the equipment of the agricultural vehicle: seat and/or engine and/or tank and/or hydraulic unit and/or other equipment. Advantageously, the width of such a platform corresponds to the minimum width of the chassis according to the invention and it is connected to each lateral half-chassis by cross-members that are connected so as to be able to slide in relation to the platform when the width of the chassis is adjusted.

In particular, a chassis according to the invention comprises at least one upper platform disposed on the chassis at a height level that is above that of each torque link of said adjustment device.

In some possible advantageous embodiments, a chassis according to the invention comprises a rear upper platform extending rearwards as an overhang, above the upper ends of the rear uprights. Such a rear upper platform can be supported by an upper extension towards the rear of the plates bolted on either side of each rear upright and/or by upper rear spars fixed to the rear ends of the rear uprights.

The invention extends to an agricultural vehicle, in particular to a self-propelled vehicle, comprising a chassis according to the invention.

An agricultural vehicle according to the invention advantageously comprises wheels fitted in the lower part of the uprights of the chassis. In particular, a front wheel can be provided that is fitted in the lower part towards the front of each front upright and a rear wheel can be fitted in the lower part towards the rear of each rear upright.

In some advantageous embodiments, each wheel is directional and independent, i.e. can be oriented independently of the other wheels. Advantageously, each wheel can be oriented relative to the longitudinal axis at an orientation angle that can range between 0° and 90°. For an orientation angle of 0° for each wheel, the vehicle moves along the longitudinal axis. For an orientation angle of 90° for each wheel, the vehicle moves orthogonal to the longitudinal axis. Furthermore, for an orientation angle of 90° for each wheel, the width adjustment of the chassis, which corresponds to an adjustment of the track of the vehicle according to the invention, can be easily implemented.

Furthermore, in some advantageous embodiments, each wheel is a drive wheel and is independent, i.e. can be rotated independently of the other wheels. Advantageously, each wheel is coupled to the horizontal drive shaft of a motor that is specific thereto. This motor is supported at the lower end by a hub-carrier pivotably mounted about a vertical axis in relation to an arch assembled on the upright of the corresponding lateral half-chassis and supporting an actuator arranged to control the angular position of the hub-carrier. The arch is advantageously assembled on the upright by means of a deformable parallelogram structure having two pivots hinged one above the other on the upright along horizontal pivot axes, and two pivots hinged one above the other on the arch along horizontal pivot axes.

The invention also relates to a chassis and to an agricultural vehicle characterised, in combination or separately, by all or some of the features mentioned above or hereafter. Regardless of the formal presentation that is provided, unless otherwise explicitly stated, the various features mentioned above or hereafter must not be considered to be closely or inextricably linked to each other, the invention can relate to only one of these structural or functional features, or to only some of these structural or functional features, or to only some of one of these structural or functional features, or even to any grouping, combination or juxtaposition of all or some of these structural or functional features.

Further aims, features and advantages of the invention will become apparent from reading the following description, which is provided by way of a non-limiting example of some of the possible embodiments of the invention, and which refers to the accompanying figures, in which:

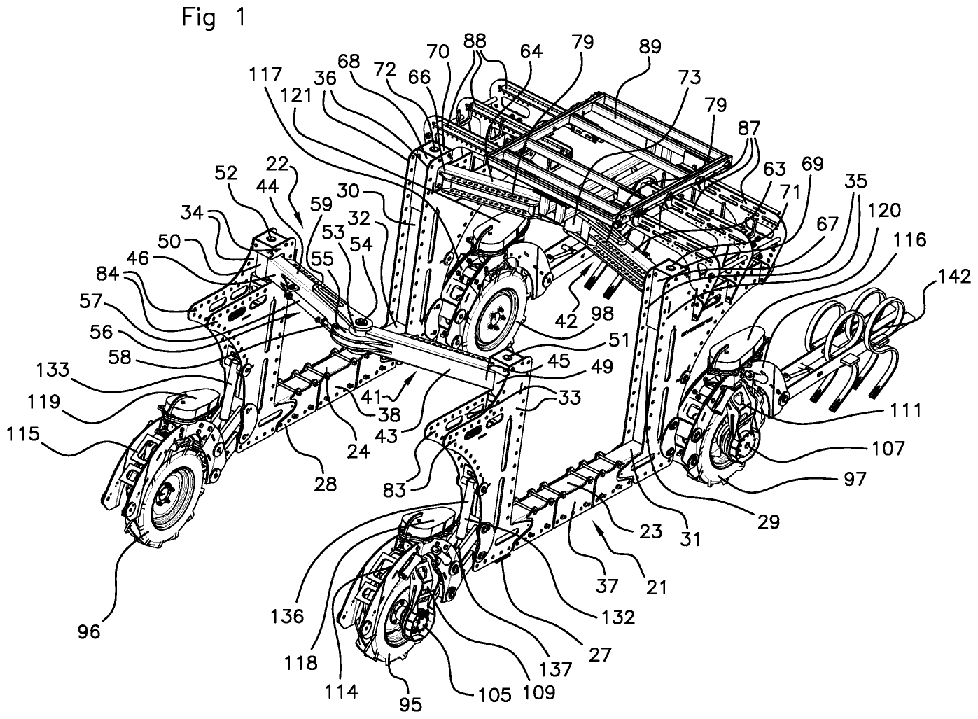

FIG. 1 is a schematic, front and top three-quarter perspective view of a chassis according to one embodiment of the invention, with the wheels being oriented at 0°,

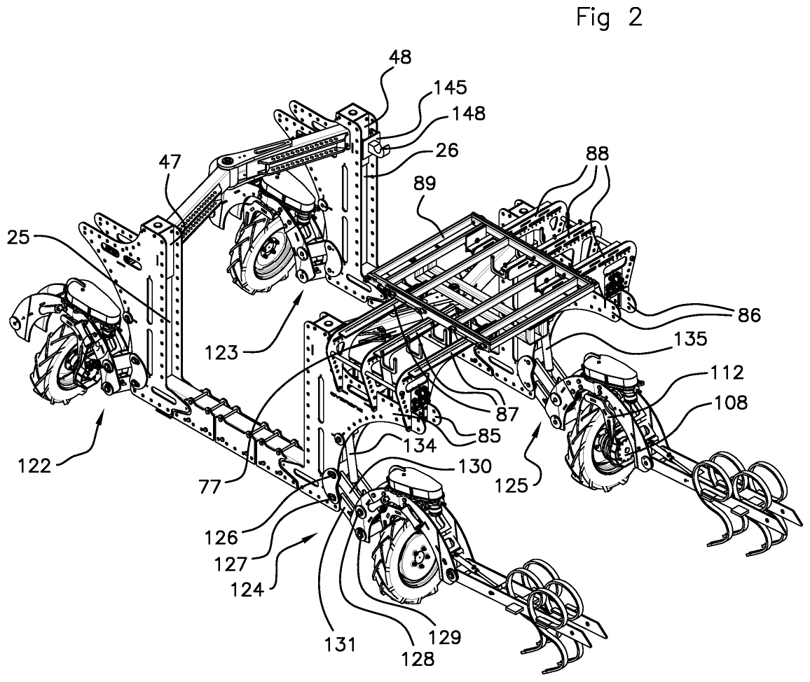

FIG. 2 is a schematic, rear and top three-quarter perspective view of the chassis of FIG. 1, with the wheels being oriented at 90°,

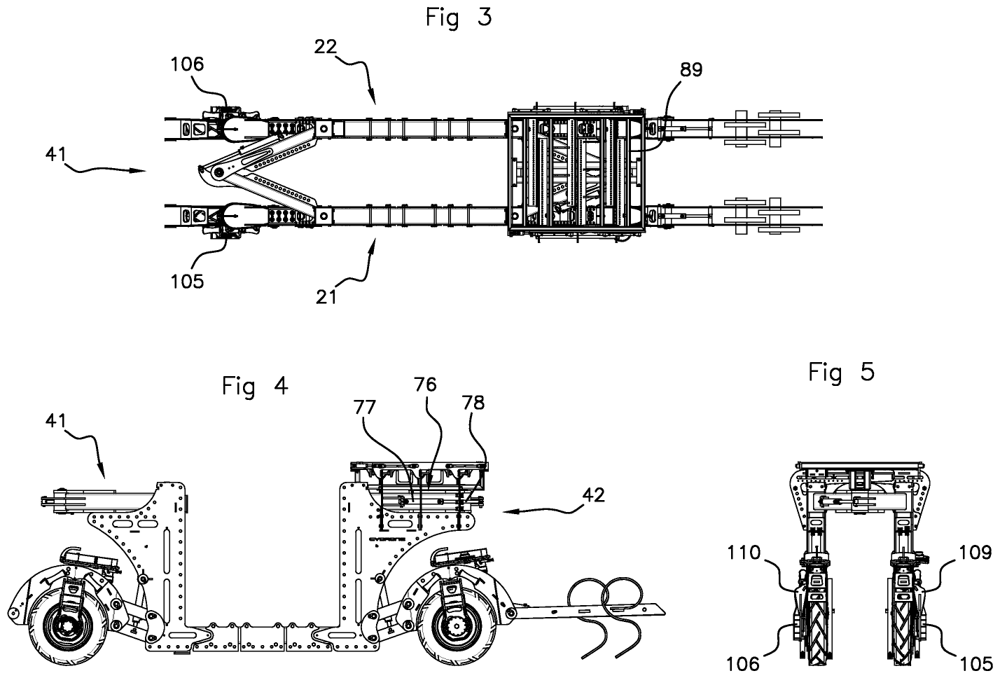

FIG. 3 is a schematic top view of the chassis of FIG. 1 in the minimum width position,

FIG. 4 is a schematic left-hand view of the chassis of FIG. 1 in the low position,

FIG. 5 is a schematic left-hand view of FIG. 4,

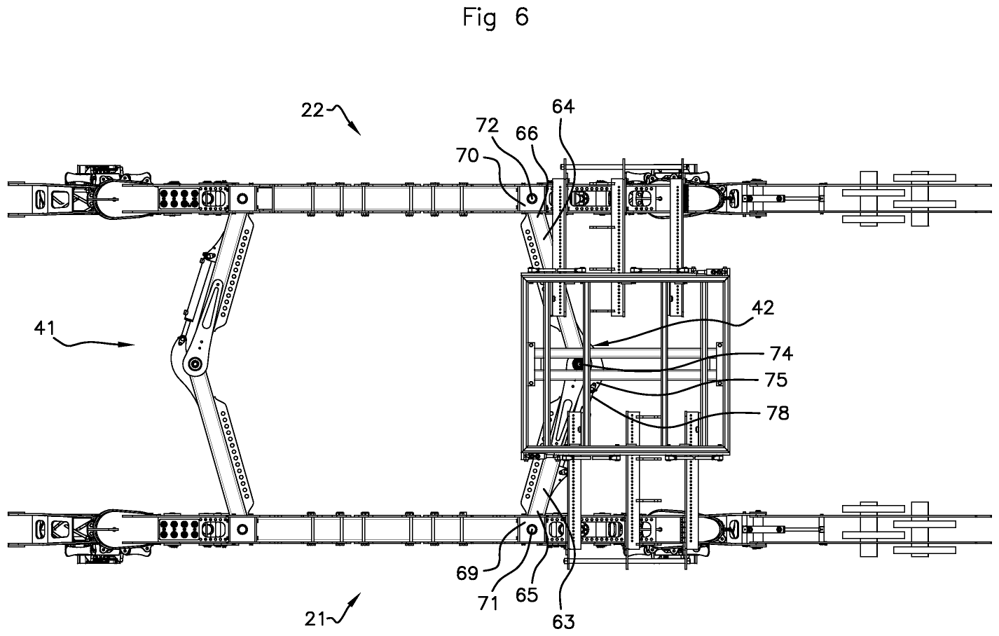

FIG. 6 is a schematic top view of the chassis of FIG. 1 in the maximum width position,

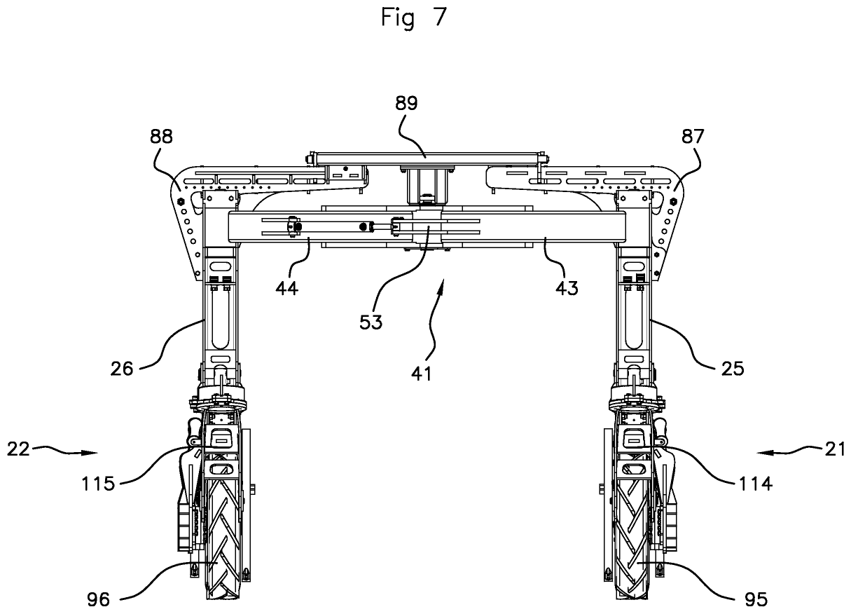

FIG. 7 is a schematic view of the front of the chassis of FIG. 1 in the maximum width position,

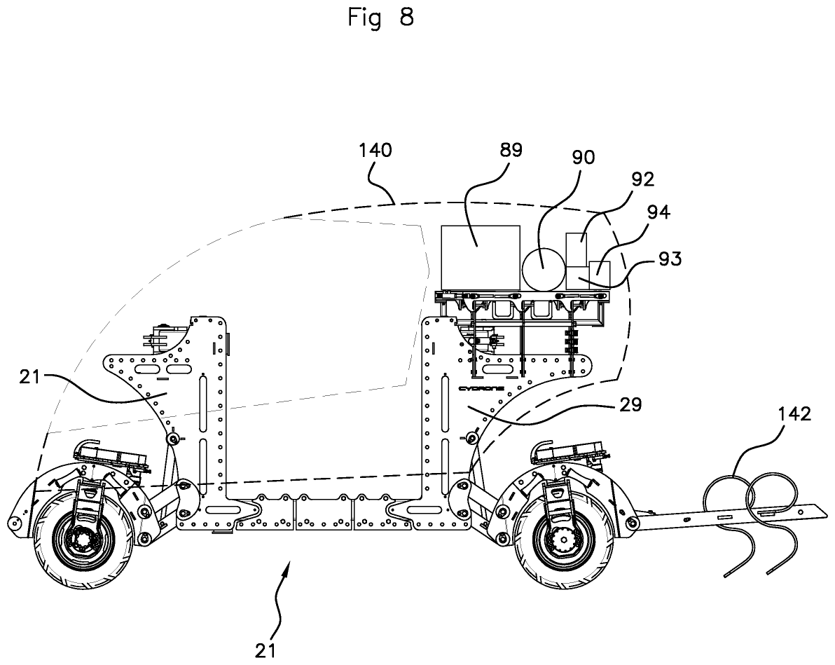

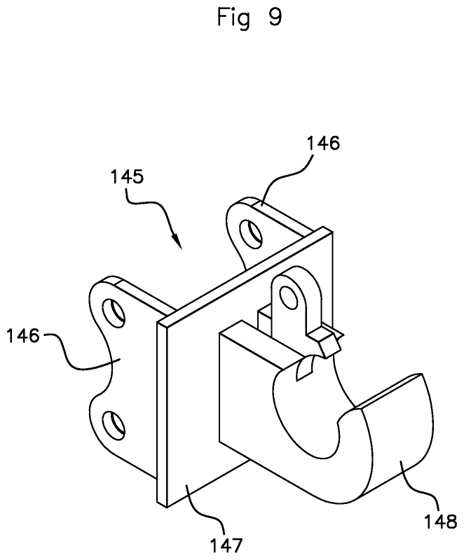

FIG. 8 is a schematic profile view of an agricultural vehicle according to the invention,

FIG. 9 is a schematic perspective view of an assembly clamp for assembling tooling on a chassis according to the invention,

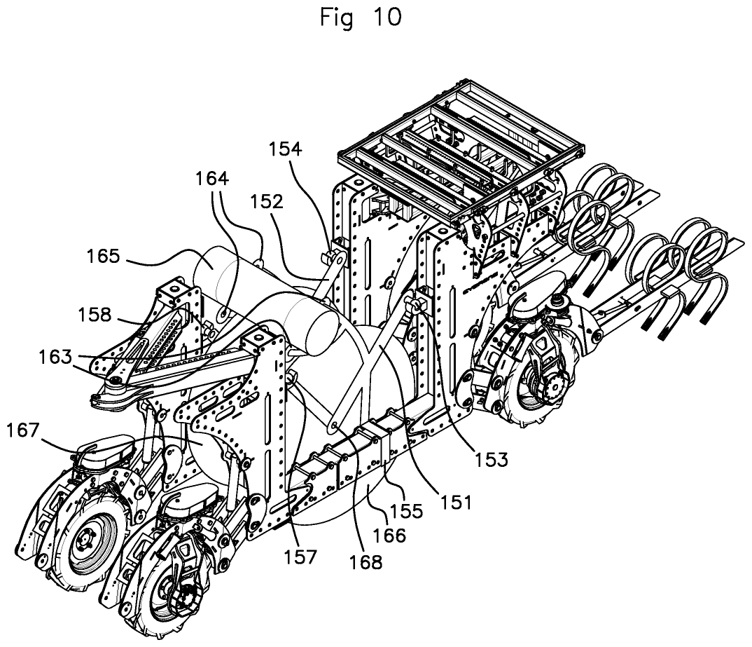

FIG. 10 is a schematic view similar to FIG. 1 showing a first example of tooling supported by the chassis according to the invention,

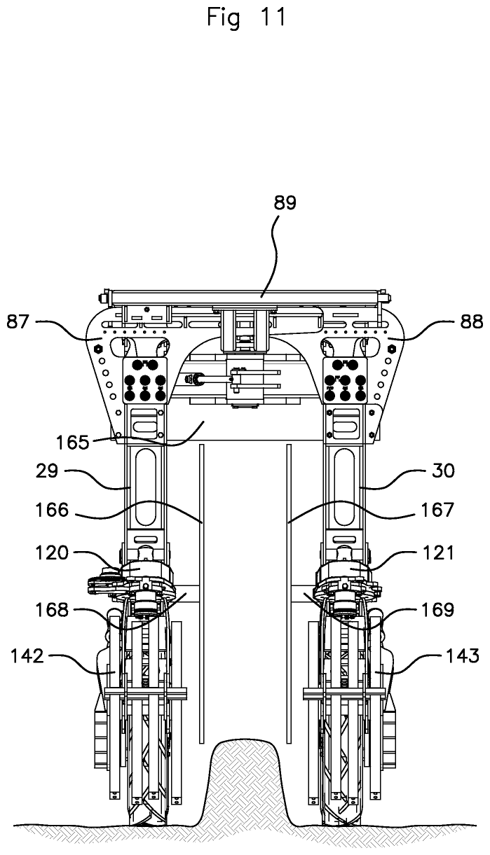

FIG. 11 is a front and partial vertical sectional view illustrating the tooling of FIG. 10 during use,

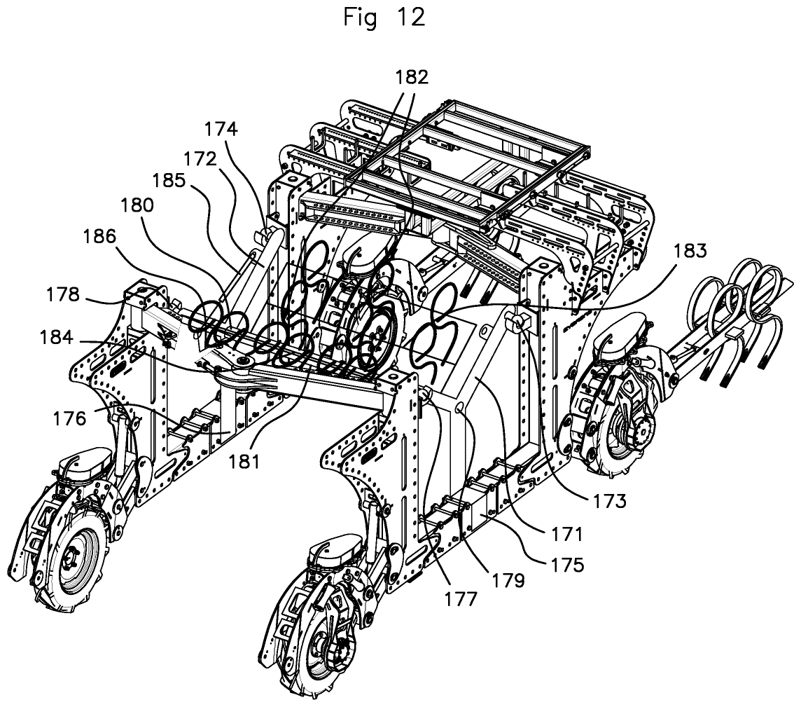

FIG. 12 is a schematic, side and top perspective view showing a second example of tooling supported by the chassis according to the invention.

Throughout the entire document, the chassis and the vehicle according to the invention are described whilst assuming that the ground on which the vehicle rests is horizontal, with the vehicle being provided with wheels defining a running surface that is also assumed to be horizontal. Of course, a vehicle according to the invention can also move over ground that is not horizontal.

A chassis according to the invention that is shown in the figures comprises:
a left-hand lateral half-chassis 21 formed by a longitudinal horizontal lower spar 23, a front upright 25 extending vertically upwards from a front end 27 of the lower spar 23, a rear upright 29 extending vertically upwards from a rear end 31 of the lower spar 23, a pair of front longitudinal vertical plates 33 fixed on either side of the front upright 25, a pair of rear longitudinal vertical plates 35 fixed on either side of the rear upright 29, and, in the example shown, pairs of longitudinal vertical plates 37 fixed on either side of the lower spar 23,
a right-hand lateral half-chassis 22 formed by a longitudinal horizontal lower spar 24, a front upright 26 extending vertically upwards from a front end 28 of the lower spar 24, a rear upright 30 extending vertically upwards from a rear end 32 of the lower spar 24, a pair of front longitudinal vertical plates 34 fixed on either side of a front upright 26, a pair of rear longitudinal vertical plates 36 fixed on either side of the rear upright 30, and, in the example shown, pairs of longitudinal vertical plates 38 fixed on either side of the lower spar 24.

The plates 33 to 38 are perforated with multiple transverse horizontal holes that allow agricultural processing equipment or devices to be attached. The plates 33 to 38 of each pair of plates are similar and are fixed together and/or to the upright 25, 26, 29, 30 or to the corresponding spar 23, 24 by bolts.

The two lateral half-chassis 21, 22 have the same shapes and dimensions. They are rigidly connected together by a front torque link 41 and a rear torque link 42 defining the transverse distance separating the two lateral half-chassis 21, 22, i.e. the width of the chassis, and allowing continuous adjustment of this width between a minimum value and a maximum value.

The front torque link 41 comprises:
a left-hand horizontal arm 43, an end 45 of which is freely hinged on the upper end 47 of the left-hand front upright 25 by a left-hand lateral joint 49 forming a non-sliding pivot with a vertical rotation axis 51,
a right-hand horizontal arm 44, an end 46 of which is freely hinged on the upper end 48 of the right-hand front upright 26 by a right-hand lateral joint 50 forming a non-sliding pivot with a vertical rotation axis 52.

The left-hand arm 43 is hinged on the right-hand arm 44 by a central joint 53 forming a non-sliding pivot with a vertical axis 54. The length of the arms 43, 44 is such that the vertical axis 54 of the central joint 53 is at an equal distance from the two axes 51, 52 of the lateral joints 49, 50. The left-hand arm 43 has an extension 55 beyond the vertical axis 54 of the central joint 53. A cylinder 56 allows the value of the angle, named torque link angle, to be controlled, which angle is formed between the two arms 43, 44 of the front torque link 41. This cylinder 56 comprises a body 57 hinged on the right-hand arm 44, and an activation rod 58, the end of which is hinged on the extension 55 of the left-hand arm 43. When the activation rod 58 of the cylinder 56 is deployed, the torque link angle decreases. When the activation rod 58 of the cylinder 56 is retracted, the torque link angle increases. When the cylinder 56 is not fed with liquid, it is locked in position, with the front torque link 41 also being locked in a determined angular position.

The arms 43, 44 of the front torque link 41 also advantageously have perforated plates 59, in particular pairs of vertically stacked perforated plates that are provided with vertical holes. In the embodiment shown, these perforated plates 59 are arranged behind the arms 43, 44 of the front torque link 41. Nothing precludes the provision, as a variant or in combination, for similar plates to be arranged in front of the arms 43, 44 of the front torque link 41.

The front torque link 41 is arranged so that the torque link angle that it forms is below 180° and has a peak that is always oriented towards the front.

The rear torque link 42 comprises:
a left-hand horizontal arm 63, an end 65 of which is freely hinged on the upper end 67 of the left-hand rear upright 29 by a left-hand lateral joint 69 forming a non-sliding pivot with a vertical rotation axis 71,
a right-hand horizontal arm 64, an end 66 of which is freely hinged on the upper end 68 of the right-hand rear upright 30 by a right-hand lateral joint 70 forming a non-sliding pivot with a vertical rotation axis 72.

The left-hand arm 63 is hinged on the right-hand arm 64 by a central joint 73 forming a non-sliding pivot with a vertical axis 74. The length of the arms 63, 64 is such that the vertical axis 74 of the central joint 73 is at an equal distance from the two axes 71, 72 of the lateral joints 69, 70. The right-hand arm 64 has an extension 75 beyond the vertical axis 74 of the central joint 73. A cylinder 76 allows the value of the angle, named torque link angle, to be controlled, which angle is formed between the two arms 63, 64 of the rear torque link 42. This cylinder 76 comprises a body 77 hinged on the left-hand arm 63, and an activation rod 78, the end of which is hinged on the extension 75 of the right-hand arm 64. When the activation rod 78 of the cylinder 76 is deployed, the torque link angle decreases. When the activation rod 78 of the cylinder 76 is retracted, the torque link angle increases. When the cylinder 76 is not fed with liquid, it is locked in position, with the rear torque link 42 also being locked in a determined angular position.

In some embodiments, not shown, at least one first strengthening cylinder is used to avoid an undesired rotation at the links between each arm of at least one front torque link and the two lateral half-chassis. In particular, preferably, a first strengthening cylinder is used to avoid an undesired rotation at the links between each arm of the front torque link and the two lateral half-chassis. A second strengthening cylinder is used to avoid an undesired rotation at the links between each arm of the rear torque link and the two lateral half-chassis. The first strengthening cylinder comprises a body hinged on the left-hand front upright, and an activation rod, the end of which is hinged on the left-hand arm of the front torque link. The second strengthening cylinder comprises a body hinged on the right-hand rear upright, and an activation rod, the end of which is hinged on the right-hand arm of the rear torque link. Thus, each strengthening cylinder prevents a movement of the half-chassis in relation to each other. Each strengthening cylinder thus allows the rigidity of the chassis to be improved.

Preferably, each strengthening cylinder is placed inside the torque link on which it is assembled, i.e. between the two arms of the torque link. Furthermore, as shown in the figures, the cylinders 56 and 76 are disposed on the outside of the torque link on which they are assembled, with the outside being opposite the inside.

The arms 63, 64 of the rear torque link 42 also advantageously have perforated plates 79, in particular pairs of vertically stacked perforated plates that are provided with vertical holes allowing agricultural processing equipment or devices to be attached. In the embodiment shown, these perforated plates 79 are arranged in front of the arms 63, 64 of the rear torque link 42. Nothing precludes, as a variant or in combination, similar plates from being arranged behind the arms 63, 64 of the rear torque link 42.

The rear torque link 42 is arranged so that the torque link angle that it forms is less than 180° and has a peak that is always oriented towards the rear.

The left-hand 43, 63 and right-hand 44, 64 arms of the torque links 41, 42 have the same lengths. The front 41 and rear 42 torque links have the same shapes and dimensions and the cylinders 56, 76 are identical so that, in any position for adjusting the width of the chassis, the front 41 and rear 42 torque links have the same torque link angle value, with their peaks being oriented in opposite directions, and the spars 23, 24 of the two lateral half-chassis 21, 22 are parallel to each other and define a longitudinal axis of the chassis and of the agricultural vehicle. Furthermore, in the embodiment shown, the front 41 and rear 42 torque links both extend in the same horizontal plane. However, nothing precludes the front 41 and rear 42 torque links from extending in separate horizontal planes.

The non-sliding pivots of each joint of each torque link 41, 42 can be produced in any manner that is well known in its own right, in particular by plain bearings and/or roller bearings.

The chassis according to the invention that is thus formed is generally symmetrical in relation to a median longitudinal vertical plane. It is also generally symmetrical in relation to a median transverse vertical plane, except for the exact shape and dimensions of the front plates 33, 34, which are slightly different from those of the rear plates 35, 36. It exhibits very high rigidity and very high resistance for low weight and great simplicity. It allows simple and reliable adjustment of the width of the chassis by modifying the torque link angle of the torque links 41, 42. It allows a large central space to be provided for the installation of various agricultural processing devices, which can be equally disposed at a height and in close proximity to the ground.

The rear perforated plates 35, 36 have extensions 85, respectively 86, extending horizontally as an overhang towards the rear of the upper ends 67, 68 of the rear uprights 29, 30. Horizontal cross-members 87 are fixed to the extension 85 of the left-hand rear perforated plates 35, so as to extend above the horizontal plane of the torque links 41, 42. Horizontal cross-members 88 are also fixed to the extension 86 of the right-hand rear perforated plates 36, so as to extend above the horizontal plane of the torque links 41, 42, with the right-hand cross-members 88 being longitudinally offset from the left-hand cross-members 87. The cross-members 87, 88 support a platform 89 that is formed, in the example shown, by a metal frame. To this end, the cross-members 87, 88 are slidably mounted below the platform 89.

The length of each cross-member 87, 88 is less than or equal to, or slightly greater than, the overall width space requirement of the chassis defined by the lateral half-chassis 21, 22 in the minimum width position. Similarly, the width of the platform 89 is less than or equal to, or slightly greater than, the overall width space requirement of the chassis defined by the lateral half-chassis 21, 22 in the minimum width position. Thus, in the minimum width position as shown in FIG. 3, the cross-members 87, 88 and the platform 89 do not substantially project outwards beyond the lateral half-chassis 21, 22.

In the example shown, in the minimum width position (FIG. 3), the torque links 41, 42 have a torque link angle that is approximately 45°. In this minimum width position, the overall width of the chassis can be, for example, typically approximately 0.8 m. In the maximum width position (in particular in FIG. 6) the torque links 41, 42 have a torque link angle that is approximately 150°. In this maximum width position, the overall width of the chassis can be, for example, typically approximately 2 m. Other values are possible.

The front perforated plates 33, 34 also advantageously have extensions 83, respectively 84, extending horizontally as an overhang towards the front of the upper ends 47, 48 of the front uprights 25, 26. These extensions 83, 84 particularly allow agricultural equipment or processing devices to be attached. Even though it is not shown in the embodiment illustrated in the figures, a horizontal platform also can be provided, which is supported by sliding cross-members fixed to the front extensions 83, 84.

The rear platform 89 particularly allows support to be provided for a heat engine 90 and its tank 91, a bank of accumulators 94, a hydraulic unit 92 connected to this heat engine 90, connected by ducts and valves to the various hydraulic actuators of the vehicle and adapted to supply a pressurised liquid, and an electronic unit 93 for controlling the whole vehicle, the hydraulic unit 92 and the various actuators, including those of the agricultural processing devices that can be installed on the vehicle.

In particular, this unit 93 allows the cylinders 56, 76 of the torque links 41, 42 to be controlled in order to vary the distance between the two half-chassis 21, 22 and the chassis width. To this end, each cylinder 56, 76 is advantageously provided with a position sensor, for example of the inductive sensor type connected to the unit 93 in order to supply it with a signal representing the position of the activation rod of the cylinder. Preferably, the unit 93 is adapted to synchronously control the two cylinders 56, 76.

Four wheels 95 to 98 are mounted in the lower part of the uprights 25, 26, 29, 30 of the chassis: a left-hand front wheel 95 is mounted in the lower part towards the front of the left-hand front upright 25, a right-hand front wheel 96 is mounted in the lower part towards the front of the right-hand front upright 26, a left-hand rear wheel 97 is mounted in the lower part towards the rear of the left-hand rear upright 29, and a right-hand rear wheel 98 is mounted in the lower part towards the rear of the right-hand rear upright 30.

Each wheel 95 to 98 is directional, is a drive wheel and is independent, i.e. can be oriented and rotated independently of the other wheels.

Each wheel 95 to 98 can be oriented relative to the longitudinal axis at an orientation angle that can range between 0° and 90°. For an orientation angle of 0° for each wheel (FIG. 1 in particular), the vehicle moves along the longitudinal axis. For an orientation angle of 90° (FIG. 2) for each wheel 95 to 98, the vehicle moves orthogonal to the longitudinal axis. Furthermore, for an orientation angle of 90° for each wheel 95 to 98, the width adjustment of the chassis, which corresponds to an adjustment of the track of the vehicle according to the invention, can be easily implemented through the simple activation of the cylinders 56, 76.

Each wheel 95 to 98 is coupled to the horizontal drive shaft of a hydraulic motor 105, respectively 106, 107, 108 that is specific thereto. This motor 105 to 108 is supported at the lower end by a hub-carrier 109, respectively 110, 111, 112 pivotably mounted about a vertical axis in relation to an arch 114, respectively 115, 116, 117 assembled on the upright 25, 26, 29, 30 of the corresponding lateral half-chassis 21, 22 and supporting an actuator 118, respectively 119, 120, 121 (rotary cylinder) arranged to control the angular position of the hub-carrier 109, respectively 110, 111, 112. The arch 114 to 117 is advantageously assembled at the lower end of the upright 25, 26, 29, 30 by means of a structure 122, respectively 123, 124, 125 with a deformable parallelogram.

Each structure 122 to 125 with a deformable parallelogram has two pivots 126, 127 hinged on top of each other on the upright 25, 26, 29, 30 (in particular on the perforated plates 33 to 36 fixed to this upright) along horizontal pivot axes, two pivots 128, 129 hinged on top of each other on the arch 114 to 117 along horizontal pivot axes. The plane of the pivot axes of the pivots 126, 127 is parallel to the plane of the pivot axes of the pivots 128, 129. These planes are at least substantially vertical. Two parallel arms 130, 131 of the same length connect the pivots 126 to 129 so as to form a deformable parallelogram. A first arm 130 connects the upper pivots 126 and 128. A second arm 131 connects the lower pivots 127 and 129.

A cylinder 132, respectively 133, 134, 135 is inserted between the upright 25, 26, 29, 30 and the upper arm 130 of each structure 122, respectively 123, 124, 125 with a deformable parallelogram. Each cylinder 132 to 135 comprises a cylinder body 136 hinged along a horizontal pivot axis transverse to the corresponding upright 25, 26, 29, 30 (in particular to the perforated plates 33 to 36 fixed to this upright), and an activation rod 137 hinged along a horizontal pivot axis transverse to the upper arm 130. When the cylinders 132 to 135 are deployed, the wheels 95 to 98 are moved downwards in relation to the chassis, which allows said chassis to be raised from the ground (as is particularly shown in FIGS. 1 and 2). When the cylinders 132 to 135 are retracted, the wheels 95 to 98 are moved upwards in relation to the chassis, which allows said chassis to be lowered towards the ground (as is particularly shown in FIGS. 4 and 5).

Various agricultural processing devices can be easily and rapidly installed in a detachable manner on a chassis according to the invention. To this end, it is possible, for example, to use an assembly clamp 145, as shown in FIG. 9, comprising two perforated lateral flanges 146 supporting a plate 147 provided with a coupling hook 148 capable of receiving a coupling ball of agricultural tooling. The flanges 146 and the holes that they include are adapted to allow detachable fixing, using bolts, of the assembly clamp 145 between the parallel perforated plates of each pair of perforated plates 33 to 36 of the chassis. An assembly clamp 145 is thus shown in FIG. 2 by way of example fixed to the right-hand front upright 26.

FIGS. 10 and 11 show an example of agricultural tooling that can be installed on a chassis according to the invention for mulching mounds of earth. This tooling comprises a support 151 mounted on the left-hand lateral half-chassis 21 and a right-hand support 152 mounted on the right-hand lateral half-chassis 22. Each support 151, 152 is fixed to the corresponding rear upright 29, 30 by an assembly clamp 145 receiving a coupling ball 153, 154 of the support 151, 152, as described above. Each support 151, 152 is also supported by the corresponding spar 23, 24 by virtue of a stirrup 155, 156. Each support 151, 152 is fixed to the corresponding front upright 25, 26 by an assembly clamp 145 receiving a coupling ball 157, 158 of the support 151, 152. Each support 151, 152 also comprises a pair of rollers 163, 164 mounted for free rotation at the end of the arm about transverse horizontal axes of rotation, with the rollers of each pair of rollers being longitudinally spaced apart in order to be able to together receive and rotationally guide a reel 165 of mulching film extending along the width of the chassis, in the upper part of the supports 151, 152, as shown in FIG. 10.

Each support 151, 152 also supports, inside the corresponding half-chassis 21, 22, a disc 166, 167 mounted for free rotation in relation to the support 151, 152 about a transverse horizontal axis of rotation 168, 169, with the axes of rotation 168, 169 of the two discs 166, 167 being co-linear. The two discs 166, 167 are the same size, are parallel to each other, each extend in a longitudinal vertical plane and allow the mulching film to be unwound and applied around a mound of earth, as shown in FIG. 11. As can be seen, with this tooling, the width of the chassis is adjusted to a low value that is selected as a function of the width of the mound of earth to be mulched, for example to its minimum value, so that the two discs 66, 167 extend on either side of the mound of earth.

FIG. 12 shows an example of two-way hoeing tooling that can be detachably installed on a chassis according to the invention. In this example, the tooling also comprises a left-hand support 171 mounted on the left-hand lateral half-chassis 21 and a right-hand support 172 mounted on the right-hand lateral half-chassis 22. Each support 171, 172 is fixed to the corresponding rear upright 29, 30 by an assembly clamp 145 receiving a coupling ball 173, 174 of the support 171, 172, as described above. Each support 171, 172 is also supported by the corresponding spar 23, 24 by virtue of a stirrup 175, 176. Each support 171, 172 is fixed to the corresponding front upright 25, 26 by an assembly clamp 145 receiving a coupling ball 177, 178 of the support 171, 172. Each support 171, 172 supports a bearing 179, 180 for rotationally guiding a transverse horizontal shaft 181 of two-way hoeing equipment 182 comprising, behind the transverse shaft 181, hoeing tools 183 adapted to hoe the earth when the vehicle moves forwards and, in front of the transverse shaft 181, hoeing tools 184 adapted to hoe the earth when the vehicle moves backwards. The angular position of the shaft 181 and of the hoeing equipment 182 is adjusted by a cylinder 185 inserted between the right-hand support 172 and a connecting rod 186 rotationally secured to the shaft 181. When the cylinder 185 is retracted, the hoeing tools 183 towards the front are in the low working position and the hoeing tools 184 towards the rear are in the high inactive position. When the cylinder 185 is deployed, the hoeing tools 183 towards the front are in the high inactive position and the hoeing tools 184 towards the rear are in the low working position.

Numerous other examples of agricultural processing devices can be installed on a chassis according to the invention: spraying devices, tanks, shaping tools, ploughing tools, seeders, vegetation crushing tools, clipping tools, planting tools, grubbing tools and accessories, spreading tools, watering tools, drip laying tools or other irrigation machinery, pruning tools, weed control tools, trimming tools, harvesting or gathering tools or accessories.

As shown in FIG. 8, a vehicle according to the invention can comprise protective bodywork 140. Furthermore, track eliminator tooling 142, 143 can be fixed behind the rear wheels 97, 98.

A vehicle according to the invention can also comprise a seat and a driving cab supported by the vehicle allowing a driver to drive the vehicle. Such a seat can be fixed, for example, in the lower part of the chassis, on the outside of one of the spars 23, 24. It also can be used to accommodate a human operator performing manual processing.

As a variant, a vehicle according to the invention can be controlled remotely, either by a human operator using a remote control, or even automatically and robotically from a control unit. Such a control unit also even can be incorporated in the vehicle according to the invention, which is then fully autonomous with respect to its movements and can be guided by virtue of satellite location and/or by any device that is known in its own right that allows autonomous guidance of self-propelled vehicles.

The invention is applicable to any agricultural vehicle, in particular for market gardening, wine growing, fruit growing, large-scale growing (in particular cereal cropping and oleaginous products). A single vehicle according to the invention can be easily used by the farmer for various applications, for example market gardening and/or wine growing and/or fruit growing and/or asparagus growing or other applications.

The invention can be the subject of numerous variants and applications other than those described above. In particular, it is obvious that, unless otherwise indicated, the various structural and functional features of each of the embodiments described above should not be considered to be combined and/or closely and/or inextricably linked to each other, but on the contrary should be considered to be simple juxtapositions. Furthermore, the structural and/or functional features of the various embodiments described above can be the subject, fully or partly, of any different juxtaposition or of any different combination.
1/- An agricultural vehicle chassis comprising:
two lateral half-chassis connected to each other at a distance from each other so as to form a rigid structure,
a device for adjusting the relative distance between the two lateral half-chassis, said adjustment device comprising:
   at least one torque link;
      comprising two rigid arms, which are hinged in relation to each other by a joint, named central joint;
         comprising a pivot,
         and allowing the two arms to be oriented in relation to each other so that they together form an angle, named torque link angle, ranging between 0° and 180°,
      each arm of the torque link being hinged, respectively, on one of the two lateral half-chassis by a joint, named lateral joint, comprising a pivot,
      said pivots of the central joint and of the lateral joints having pivot axes that are parallel to each other,
   a device for adjusting the torque link angle, said device for adjusting the torque link angle being adapted to allow the torque link angle to be locked once adjusted,
characterised in that the device for adjusting the torque link angle of at least one torque link comprises a cylinder comprising a body supported by one of the two arms of the torque link and an activation rod hinged on the other arm of the torque link.

2/- The chassis according to claim 1, wherein the device for adjusting the torque link angle of at least one torque link is adapted to allow angular adjustment of the central joint and to allow said central joint to be locked once adjusted.

3/- The chassis according to claim 1, wherein the device for adjusting the torque link angle of at least one torque link is adapted to set a value for the torque link angle that is above 0° and below 180°, values excluded.

4/- The chassis according to claim 1, wherein the adjustment device also comprises at least one strengthening cylinder comprising:
a body supported by one from among a lateral half-chassis and an arm of a torque link, the arm being hinged on this half-chassis, and
an activation rod supported by the other one from among said lateral half-chassis and said arm of said torque link.

5/- The chassis according to claim 1, wherein said adjustment device comprises a plurality of torque links and a unit for controlling the device for adjusting the torque link angle of the various torque links, said control unit being adapted to maintain the same relative orientation of the two lateral half-chassis in relation to each other.

6/- The chassis according to claim 1, wherein the central joint of at least one torque link comprises a non-sliding pivot with a vertical axis, and in that each lateral joint of at least one torque link comprises a non-sliding pivot with a vertical axis.

7/- The chassis according to claim 1, wherein said adjustment device comprises at least one front torque link, for which the peak of the torque link angle is oriented towards the front, and at least one rear torque link, for which the peak of the torque link angle is oriented towards the rear.

8/- The chassis according to claim 7, wherein the front and rear torque links have the same dimensions and the same torque link angles.

9/- The chassis according to claim 1, wherein each lateral half-chassis comprises:
a spar,
a front upright extending vertically at least upwards from a front end of the spar,
a rear upright extending vertically at least upwards from a rear end of the spar,
and in that the adjustment device comprises a front torque link extending between the front uprights hinged thereon, and a rear torque link extending between the rear uprights and hinged thereon.

10/- The chassis according to claim 9, wherein each torque link is hinged between upper ends of said uprights.

11/- An agricultural vehicle comprising a chassis according to claim 1.
